(19) United States
(12) Patent Application Publication
(10) Pub. No.: US 2024/0070397 A1
(43) Pub. Date: Feb. 29, 2024

(54) HUMAN-COMPUTER INTERACTION METHOD, APPARATUS AND SYSTEM, ELECTRONIC DEVICE AND COMPUTER MEDIUM

(71) Applicants: Beijing Wodong Tianjun Information Technology Co., Ltd., Beijing (CN); Beijing Jingdong Century Trading Co., Ltd., Beijing (CN)

(72) Inventors: Xin YUAN, Beijing (CN); Junyi WU, Beijing (CN); Yuyu CAI, Beijing (CN); Zhengchen ZHANG, Beijing (CN); Dan LIU, Beijing (CN); Xiaodong HE, Beijing (CN)

(73) Assignees: Beijing Wodong Tianjun Information Technology Co., Ltd., Beijing (CN); Beijing Jingdong Century Trading Co., Ltd., Beijing (CN)

(21) Appl. No.: 18/271,609

(22) PCT Filed: Dec. 15, 2021
(86) PCT No.: PCT/CN2021/138297

§ 371 Date: Jul. 10, 2023

(30) Foreign Application Priority Data
Feb. 9, 2021 (CN) 202110174149.1

(51) Int. Cl. G06F 40/30; G06F 40/20; G06T 13/20; G06T 13/40; G06V 40/16

(52) U.S. Cl. CPC G06F 40/30; G06F 40/20; G06T 13/205; G06T 13/40; G06V 40/174

(57) ABSTRACT

A human-computer interaction method and apparatus. Said method may include: receiving information of at least one modality of a user (201); identifying, on the basis of the information of the at least one modality, intention information of the user and user emotional features corresponding to the intention information (202); determining, on the basis of the intention information, reply information to the user (203); selecting, on the basis of the user emotional features, character emotional features to be fed back to the user (204); and generating, on the basis of the character emotional features and the reply information, a broadcast video of an animated character corresponding to the character emotional features (205).

### CROSS-REFERENCE TO RELATED APPLICATIONS

The present disclosure is a U.S. National Stage of International Application No. PCT/CN2021/138297, filed on Dec. 15, 2021, which claims priority to Chinese Patent Application No. 202110174149.1 filed on Feb. 9, 2021 and entitled “Method, Apparatus and System for Human-computer Interaction, Electronic Device, and Computer Medium”, the entire contents of which are hereby incorporated by reference.

### TECHNICAL FIELD

The present disclosure relates to the technical field of artificial intelligence, specifically relates to the technical field, such as computer vision and deep learning, and more specifically relates to a method and apparatus for human-computer interaction, an electronic device, a computer-readable medium, and a computer program product.

### BACKGROUND

A conventional customer service system of a virtual digital people can only complete simple human-computer interaction, may be understood as an emotionless robot, and only achieves simple speech recognition and semantic understanding. A complex counter customer service system is impossible to make emotional responses to users with different emotions only through simple speech recognition and semantic understanding, thus resulting in poor user interaction experience.

### SUMMARY

Embodiments of the present disclosure provides a method and apparatus for human-computer interaction, an electronic device, and a computer-readable medium.

In a first aspect, an embodiment of the present disclosure provides a method for human-computer interaction, including: receiving information of at least one modality of a user; recognizing intention information of the user and an emotional characteristic of the user corresponding to the intention information based on the information of the at least one modality; determining reply information to the user based on the intention information; selecting an emotional characteristic of a character to be fed back to the user based on the emotional characteristic of the user; and generating a broadcast video of an animated character image corresponding to the emotional characteristic of the character based on the emotional characteristic of the character and the reply information.

In some embodiments, the information of the at least one modality includes image data and audio data of the user, and the recognizing the intention information of the user and the emotional characteristic of the user corresponding to the intention information based on the information of the at least one modality includes: recognizing an expression characteristic of the user based on the image data of the user; obtaining text information from the audio data; extracting the intention information of the user based on the text information; and obtaining the emotional characteristic of the user corresponding to the intention information based on the audio data and the expression characteristic.

In some embodiments, the recognizing the intention information of the user and the emotional characteristic of the user corresponding to the intention information based on the information of the at least one modality further includes: obtaining the emotional characteristic of the user further from the text information.

In some embodiments, obtaining the emotional characteristic of the user corresponding to the intention information based on the audio data and the expression characteristic includes: inputting the audio data into a trained speech emotion recognition model to obtain a speech emotion characteristic outputted from the speech emotion recognition model; inputting the expression characteristic into a trained expression emotion recognition model to obtain an expression emotion characteristic outputted from the expression emotion recognition model; and performing weighted summation on the speech emotion characteristic and the expression emotion characteristic to obtain the emotional characteristic of the user corresponding to the intention information.

In some embodiments, the information of the at least one modality includes image data and text data of the user; and the recognizing the intention information of the user and the emotional characteristic of the user corresponding to the intention information based on the information of the at least one modality includes: recognizing an expression characteristic of the user based on the image data of the user; extracting the intention information of the user based on the text data; and obtaining the emotional characteristic of the user corresponding to the intention information based on the text data and the expression characteristic.

In some embodiments, generating the broadcast video of the animated character image corresponding to the emotional characteristic of the character based on the emotional characteristic of the character and the reply information includes: generating a reply audio based on the reply information and the emotional characteristic of the character; and obtaining the broadcast video of the animated character image corresponding to the emotional characteristic of the character based on the reply audio, the emotional characteristic of the character, and a pre-established animated character image model.

In some embodiments, obtaining the broadcast video of the animated character image corresponding to the emotional characteristic of the character based on the reply audio, the emotional characteristic of the character, and the pre-established animated character image model includes: inputting the reply audio and the emotional characteristic of the character into a trained mouth shape driving model to obtain mouth shape data outputted from the mouth shape driving model; inputting the reply audio and the emotional characteristic of the character into a trained expression driving model to obtain expression data outputted from the expression driving model; driving the animated character image model based on the mouth shape data and the expression data to obtain a three-dimensional model action sequence; rendering the three-dimensional model action sequence to obtain a video frame picture sequence; and synthesizing the video frame picture sequence to obtain the broadcast video of the animated character image corresponding to the emotional characteristic of the character, where the mouth shape driving model and the expression driving model are trained based on a pre-annotated audio of a same person and audio emotion information obtained from the audio.

In a second aspect, an embodiment of the present disclosure provides an apparatus for human-computer interaction, including: a receiving unit configured to receive information of at least one modality of a user; a recognition unit configured to recognize intention information of the user and an emotional characteristic of the user corresponding to the intention information based on the information of the at least one modality; a determination unit configured to determine reply information to the user based on the intention information; a selection unit configured to select an emotional characteristic of a character to be fed back to the user based on the emotional characteristic of the user; and a broadcasting unit configured to generate a broadcast video of an animated character image corresponding to the emotional characteristic of the character based on the emotional characteristic of the character and the reply information.

In some embodiments, the information of the at least one modality includes image data and audio data of the user. The recognition unit includes: a recognition subunit configured to recognize an expression characteristic of the user based on the image data of the user; a text obtaining subunit configured to obtain text information from the audio data; an extraction subunit configured to extract the intention information of the user based on the text information; and a characteristic obtaining subunit configured to obtain the emotional characteristic of the user corresponding to the intention information based on the audio data and the expression characteristic.

In some embodiments, the emotional characteristic of the user in the recognition unit is further obtained from the text information.

In some embodiments, the characteristic obtaining subunit includes: a speech obtaining module configured to input the audio data into a trained speech emotion recognition model to obtain a speech emotion characteristic outputted from the speech emotion recognition model; an expression obtaining module configured to input the expression characteristic into a trained expression emotion recognition model to obtain an expression emotion characteristic outputted from the expression emotion recognition model; and a summation module configured to perform weighted summation on the speech emotion characteristic and the expression emotion characteristic to obtain the emotional characteristic of the user corresponding to the intention information.

In some embodiments, the information of the at least one modality includes the image data and the audio data of the user, and the recognition unit includes: a recognition module configured to recognize the expression characteristic of the user based on the image data of the user; an extraction module configured to extract the intention information of the user based on text data; and a characteristic obtaining module configured to obtain the emotional characteristic of the user corresponding to the intention information based on the text data and the expression characteristic.

In some embodiments, the broadcasting unit includes: a generation subunit configured as the broadcasting unit; and a video obtaining subunit configured to obtain the broadcast video of the animated character image corresponding to the emotional characteristic of the character based on the reply audio, the emotional characteristic of the character, and a pre-established animated character image model.

In some embodiments, the video obtaining subunit includes: a mouth shape driving module configured to input the reply audio and the emotional characteristic of the character into a trained mouth shape driving model to obtain mouth shape data outputted from the mouth shape driving model; an expression driving module configured to input the reply audio and the emotional characteristic of the character into a trained expression driving model to obtain expression data outputted from the expression driving model; a model driving module configured to drive the animated character image model based on the mouth shape data and the expression data to obtain a three-dimensional model action sequence; a picture obtaining module configured to render the three-dimensional model action sequence to obtain a video frame picture sequence; and a video obtaining module configured to synthesize the video frame picture sequence to obtain the broadcast video of the animated character image corresponding to the emotional characteristic of the character. The mouth shape driving model and the expression driving model are trained based on a pre-annotated audio of the same person and audio emotion information obtained from the audio.

In a third aspect, an embodiment of the present disclosure provides a system for human-computer interaction, including: a collection device, a display device, and an interaction platform connected to the collection device and the display device respectively; where the collection device is configured to collect information of at least one modality of a user; the interaction platform is configured to receive the information of the at least one modality of the user; recognize intention information of the user and an emotional characteristic of the user corresponding to the intention information based on the information of the at least one modality; determine reply information to the user based on the intention information; select an emotional characteristic of a character to be fed back to the user based on the emotional characteristic of the user; and generate a broadcast video of an animated character image corresponding to the emotional characteristic of the character based on the emotional characteristic of the character and the reply information; and the display device is configured to receive and play the broadcast video.

In a fourth aspect, an embodiment of the present disclosure provides an electronic device, including: one or more processors; and a storage apparatus storing one or more programs thereon, where the one or more programs, when executed by the one or more processors, cause the one or more processors to implement the method according to any implementation in the first aspect.

In a fifth aspect, an embodiment of the present disclosure provides a computer-readable medium, storing a computer program thereon, where the program, when executed by a processor, implements the method according to any implementation in the first aspect.

### BRIEF DESCRIPTION OF THE DRAWINGS

After reading detailed descriptions of non-limiting embodiments with reference to the following accompanying drawings, other features, objectives, and advantages of the present disclosure will become more apparent.

FIG. 1 is a diagram of an example system architecture in which an embodiment of the present disclosure may be implemented;

FIG. 2 is a flowchart of a method for human-computer interaction according to an embodiment of the present disclosure;

FIG. 3 is a flowchart of recognizing intention information of a user and an emotional characteristic of the user according to an embodiment of the present disclosure;

FIG. 4 is a schematic structural diagram of an apparatus for human-computer interaction according to an embodiment of the present disclosure;

FIG. 5 is a schematic structural diagram of a system for human-computer interaction according to an embodiment of the present disclosure; and

FIG. 6 is a schematic structural diagram adapted to implementing an electronic device of embodiments of the present disclosure.

### DETAILED DESCRIPTION OF EMBODIMENTS

The present disclosure will be further described in detail below with reference to the accompanying drawings and the embodiments. It should be understood that the specific embodiments described here are merely used for explaining the relevant disclosure, rather than limiting the disclosure. In addition, it should be further noted that, for ease of description, only the portions related to the relevant disclosure are shown in the drawings.

It should be noted that the embodiments in the present disclosure and the features in the embodiments may be combined with each other on a non-conflict basis. The present disclosure will be described in detail below with reference to the drawings and in combination with the embodiments.

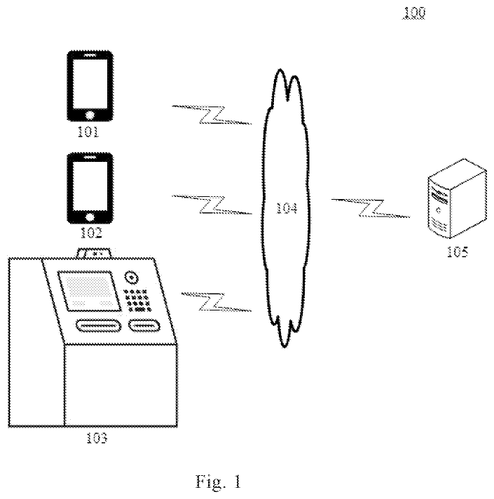

FIG. 1 shows an example system architecture 100 in which a method for human-computer interaction of the present disclosure may be implemented.

As shown in FIG. 1, the system architecture 100 may include a terminal device 101, a terminal device 102, an automatic teller machine 103, a network 104, and a server 105. The network 104 serves as a medium providing a communication link between the terminal device 101, the terminal device 102, the automatic teller machine 103, and the server 105. The network 104 may include various types of connections, and generally may include a wireless communication link, etc.

The terminal device 101, the terminal device 102, and the automatic teller machine 103 interact with the server 105 through the network 104, for example, to receive or send a message. The terminal device 101, the terminal device 102, and the automatic teller machine 103 may be provided with various communication client applications, such as an instant messaging tool or an email client.

The terminal devices 101 and 102 may be hardware, or may be software. When the terminal devices 101 and 102 are hardware, the terminal devices may be user devices with communication and control functions, and the user devices may communicate with the server 105. When the terminal devices 101 and 102 are software, the terminal devices may be installed in the above user devices. The terminal devices 101 and 102 may be implemented as a plurality of software programs or software modules (e.g., software or software modules for providing distributed services), or may be implemented as an individual software program or software module. This is not specifically limited here.

The server 105 may be a server providing various services, such as a back-end server providing support for a client question-answering (QA) system on the terminal device 101, the terminal device 102, or the automatic teller machine 103. The back-end server can analyze and process information of at least one modality of a relevant user collected on the terminal device 101, the terminal device 102, or the automatic teller machine 103, and feed back the processing result (such as a broadcast video of an animated character image) to the terminal devices or the automatic teller machine.

It should be noted that the server may be hardware, or may be software. When the server is hardware, the server may be implemented as a distributed server cluster composed of a plurality of servers, or may be implemented as a single server. When the server is software, the server may be implemented as a plurality of software programs or software modules (e.g., software or software modules for providing distributed services), or may be implemented as an individual software program or software module. This is not specifically limited here.

It should be noted that the method for human-computer interaction provided in embodiments of the present disclosure is generally executed by the server 105.

It should be understood that the numbers of terminal devices, networks, and servers in FIG. 1 are merely illustrative. Any number of terminal devices, networks, and servers may be provided based on actual requirements.

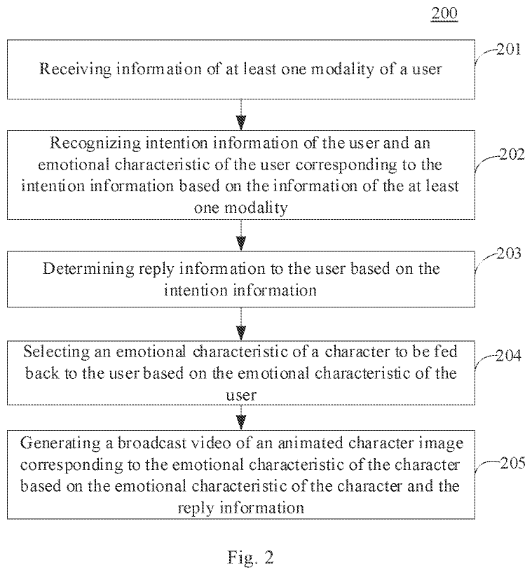

As shown in FIG. 2, a process 200 of a method for human-computer interaction according to an embodiment of the present disclosure is shown. The method for human-computer interaction includes the following steps.

Step 201: receiving information of at least one modality of a user.

In the present embodiment, an executing body on which the method for human-computer interaction runs can receive information of the user from different sources in the same period of time. The information from different sources is information of different modalities, and is information of at least one modality when there is a plurality of pieces of information from different sources. Specifically, the information of the at least one modality may include: one or more kinds of image data, audio data, or text data.

In the present embodiment, the information of the at least one modality of the user is information sent from the user or/and information associated with the user. For example, the image data is obtained by photographing a face of the user, body of the user, hair of the user, or the like, the audio data is obtained by recording a voice sent by the user, and the text data is data, such as a text, a symbol, or a number, inputted by the user into the executing body. A user intention may be analyzed based on the information of the at least one modality of the user, to determine, e.g., a question of the user, a purpose of the user, and an emotional state of the user when the user raises the question or inputs the information.

In practice, the information of different modalities may be descriptive information on the same thing collected by different sensors. For example, during video retrieval, the information of different modalities includes audio data and image data of the same user collected in the same period of time, where the audio data and the image data correspond to each other at the same moment. For another example, in a task-based dialogue and communication process, the user sends, e.g., the image data and the text data of the same user in the same period of time to the executing body through a user terminal.

In the present embodiment, an executing body (e.g., the server 105 shown in FIG. 1) of the method for human-computer interaction may receive the information of the at least one modality of the user by a plurality of means, for example, collects a to-be-processed data set from the user terminal (such as the terminal device 101, the terminal device 102, and the automatic teller machine 103 shown in FIG. 1) in real time, and extracts the information of the at least one modality from the to-be-processed data set, or acquires a to-be-processed data set including information of a plurality of modalities from a local memory, and extracts the information of the at least one modality from the to-be-processed data set. Alternatively, the information of the at least one modality may also be information sent from a terminal in real time.

Step 202: recognizing intention information of the user and an emotional characteristic of the user corresponding to the intention information based on the information of the at least one modality.

In the present embodiment, the intention information of the user is information characterizing, e.g., the question, the purpose, or greetings of the user. After obtaining the intention information of the user, the executing body may make different feedbacks based on different contents of the intention information.

The emotional characteristic of the user is a personal emotional state when the user sends out or presents information of different modalities. Specifically, the emotional state includes: wrath, sadness, joy, anger, disgust, and so on.

Further, the intention information of the user and the emotion characteristic of the user may be recognized based on the information of the different modalities of the user by different approaches.

In some alternative implementations of the present disclosure, the information of the at least one modality includes image data and audio data of the user, and the recognizing the intention information of the user and the emotional characteristic of the user corresponding to the intention information based on the information of the at least one modality includes: recognizing an expression characteristic of the user based on the image data of the user; obtaining text information from the audio data; extracting the intention information of the user based on the text information; and obtaining the emotional characteristic of the user corresponding to the intention information based on the audio data and the expression characteristic.

In the present alternative implementation, when the information of the at least one modality of the user includes the image data and the audio data of the user, the expression characteristic of the user is recognized based on the image data of the user; the text information is obtained based on the audio data; the intention information is extracted based on the text information; and the emotional characteristic of the user is obtained based on the audio data and the expression characteristic. Therefore, an emotion of the user is comprehensively determined based on emotions included in a facial expression (expression characteristic) and a voice (audio data) of the user, thereby improving the reliability in analyzing the emotional characteristic of the user to a certain extent.

In some alternative implementations of the present disclosure, the information of the at least one modality includes: the image data and the text data of the user, and the recognizing the intention information of the user and the emotional characteristic of the user based on the information of the at least one modality includes the following steps: recognizing the expression characteristic of the user based on the image data of the user; extracting the intention information of the user based on the text data; and obtaining the emotional characteristic of the user corresponding to the intention information based on the text data and the expression characteristic.

When the information of the modality of the user includes the image data and the text data, the method for recognizing the intention information of the user and the emotional characteristic of the user provided in the present alternative implementation recognizes the expression characteristic of the user based on the image data; extracts the intention information based on the text data; and further obtains the emotional characteristic of the user based on the text data and the expression characteristic. Therefore, the emotion of the user is comprehensively determined based on emotions included in the facial expression (expression characteristic) and a speech (text information) of the user, thereby providing a reliable emotion analyzing approach for extracting intention information and an emotion of a deaf mute.

Alternatively, the information of the at least one modality includes: the image data, the text data, and the audio data of the user. The recognizing the intention information of the user and the emotional characteristic of the user based on the information of the at least one modality includes the following steps: recognizing the expression characteristic of the user based on the image data of the user; extracting the intention information of the user based on the text data and the audio data; and obtaining the emotional characteristic of the user corresponding to the intention information based on the text data, the expression characteristic, and the audio data.

In the present alternative implementation, when the information of the at least one modality includes the image data, the text data, and the audio data of the user, the emotion of the user can be comprehensively determined based on emotions included in the facial expression (expression characteristic), the voice (audio data), and the speech (text information) of the user, thereby improving the reliability in analyzing the emotion of the user.

The text information and the text data mentioned in the present embodiment are different text manifestations, and are only used to distinguish between text sources or processing approaches.

Further, since each of the speech, text, and expression of the user can reflect the emotion of the user, the emotional characteristic of the user can be obtained. In some alternative implementations of the present embodiment, the obtaining the emotional characteristic of the user corresponding to the intention information based on the audio data and the expression characteristic includes: inputting the audio data into a trained speech emotion recognition model to obtain a speech emotion characteristic outputted from the speech emotion recognition model; inputting the expression characteristic into a trained expression emotion recognition model to obtain an expression emotion characteristic outputted from the expression emotion recognition model; and performing weighted summation on the speech emotion characteristic and the expression emotion characteristic to obtain the emotional characteristic of the user corresponding to the intention information.

In the present alternative implementation, the expression emotion characteristic is recognized through the trained expression emotion recognition model, and the speech emotion characteristic is recognized through the trained speech emotion recognition model, thereby quickly obtaining a real-time emotional state of the user from the information of the at least one modality of the user, and providing a reliable basis for achieving an emotional animated character image.

Alternatively, the obtaining the emotional characteristic of the user corresponding to the intention information based on the text data, the expression characteristic, and the audio data may further include: inputting the text data into a trained text emotion recognition model to obtain a text emotion characteristic outputted from the text emotion recognition model; inputting the audio data into the trained speech emotion recognition model to obtain the speech emotion characteristic outputted from the speech emotion recognition model; inputting the expression characteristic into the trained expression emotion recognition model to obtain the expression emotion characteristic outputted from the expression emotion recognition model; and performing weighted summation on the text emotion characteristic, the speech emotion characteristic, and the expression emotion characteristic to obtain the emotional characteristic of the user corresponding to the intention information.

In the present embodiment, the speech emotion recognition model is configured to recognize an emotional characteristic in the audio data of the user, to determine an emotional state of the user when the user makes the speech; the expression emotion recognition model is configured to recognize an emotion-related expression characteristic among the expression characteristic of the user, to determine an emotional state of the user when the user expresses an expression; and the text emotion recognition model is configured to recognize an emotional characteristic in the text data of the user, to determine the emotional state expressed by the text outputted by the user.

The expression emotion recognition model, the speech emotion recognition model, and the text emotion recognition model may be models trained on the basis of giving a large amount of annotated text data, expression characteristic, and audio data of the same user, and the obtained speech emotion characteristic, expression emotion characteristic and text emotion characteristic are all used for characterizing the emotional state of the user (joy, anger, sadness, and fear). It should be noted that the speech emotion recognition model and the expression emotion recognition model in the present alternative implementation may also be adapted to other embodiments.

Step 203: determining reply information to the user based on the intention information.

In the present embodiment, the reply information to the user is information corresponding to the intention information of the user, and the reply information is also an audio content that needs to be broadcasted for an animated character image. For example, the intention information of the user is a question: How tall is Li Si? The reply information is an answer: Li Si is 1.8 meters tall.

After obtaining the intention information of the user, the executing body can determine the reply information by various approaches, for example, by querying a knowledge base or searching a knowledge graph.

Step 204: selecting an emotional characteristic of a character to be fed back to the user based on the emotional characteristic of the user.

In the present embodiment, the emotional characteristic of the character is used for characterizing a characteristic of an emotional state of the animated character image, where the emotional state of the character may be identical to, or may be different from, an emotional state characterized by the emotional characteristic of the user. For example, when the emotional characteristic of the user is anger, the emotional characteristic of the character may be expressed as calmness; and when the emotional characteristic of the user is joy, the emotional characteristic of the character may also be expressed as joy.

After obtaining the emotional characteristic of the user, the executing body on which the method for human-computer interaction runs may select one or more emotional characteristics from a preset emotional characteristic database based on the emotional characteristic of the user for use as the emotional characteristic of the character. The emotional characteristic of the character is applied to the animated character image to realize the embodiment of the emotional characteristic of the animated character image.

Step 205: generating a broadcast video of an animated character image corresponding to the emotional characteristic of the character based on the emotional characteristic of the character and the reply information.

In the present embodiment, the broadcast video of the animated character image is a video of broadcasting information of a virtual animated character, and both the emotional characteristic of the character and the reply information are information that needs to be expressed by the animated character image. In order to vividly and intuitively express the reply information, the reply information may be converted into a reply audio. A broadcast reply audio is reflected by a virtual mouth opening action of the animated character in the broadcast video of the animated character image. The emotional characteristic of the character is reflected through virtual expression changes of the animated character.

In a process of communication between the animated character image and the user, an audio obtained from speech synthesis of the animated character image may be provided with emotional information of the character, such as a calm emotion, according to the emotional characteristic of the character. Further, a facial expression corresponding to the emotional characteristic of the character may be further selected for presentation on the face of the animated character, thereby improving expression abundance of the animated character image.

In order to make the reply audio more vivid, in some alternative implementations of the present embodiment, the generating the broadcast video of the animated character image corresponding to the emotional characteristic of the character based on the emotional characteristic of the character and the reply information includes: generating a reply audio based on the reply information and the emotional characteristic of the character; and obtaining the broadcast video of the animated character image corresponding to the emotional characteristic of the character based on the reply audio, the emotional characteristic of the character, and a pre-established animated character image model.

In the present alternative implementation, the animated character image model may be a three-dimensional model obtained through three-dimensional image modeling, where three-dimensional image modeling is a process of establishing a model with three-dimensional data through a virtual three-dimensional space using three-dimensional production software. Further, modeling may be further performed for each part of the animated character image (for example, modeling for its facial contour, independent modeling for its mouth, independent modeling for its hair, independent modeling for its trunk, independent modeling for its skeleton, or modeling for its facial expression), and selected models for various parts may be combined to obtain the animated character image model.

In the present alternative implementation, a pre-analyzed emotional factor of the character included in the reply audio is generated based on the reply information and the emotional characteristic of the character, so that the audio in the broadcast video of the animated character image contains more abundant emotions, thus moving the user; and actions of the animated character in the broadcast video of the animated character image obtained based on the emotional characteristic of the character contain more abundant emotions and are emotion-arousing.

In some alternative implementations of the present embodiment, the obtaining the broadcast video of the animated character image corresponding to the emotional characteristic of the character based on the reply audio, the emotional characteristic of the character, and the pre-established animated character image model includes: inputting the reply audio and the emotional characteristic of the character into a trained mouth shape driving model to obtain mouth shape data outputted from the mouth shape driving model; inputting the reply audio and the emotional characteristic of the character into a trained expression driving model to obtain expression data outputted from the expression driving model; driving the animated character image model based on the mouth shape data and the expression data to obtain a three-dimensional model action sequence; rendering the three-dimensional model action sequence to obtain a video frame picture sequence; and synthesizing the video frame picture sequence to obtain the broadcast video of the animated character image corresponding to the emotional characteristic of the character. The mouth shape driving model and the expression driving model are trained based on a pre-annotated audio of the same person and audio emotion information obtained from the audio.

In the present alternative implementation, the mouth shape driving model is a model configured to recognize a running trajectory of a lip of the animated character in the three-dimensional space, and the mouth shape driving model may be further combined with a mouth shape database to obtain mouth shape data of the animated character image at different moments, where the mouth shape data is also data of mouth shape changes of the animated character image.

In the present alternative implementation, the expression driving model is a model configured to recognize a running trajectory of a facial feature point of the animated character in the three-dimensional space, and may be further combined with an expression database to obtain expression data of the animated character image at different moments, where the expression data is also data of expression changes of the animated character image.

In the present alternative implementation, the mouth shape driving model and the expression driving model are trained based on the pre-annotated audio of the same person and the audio emotion information obtained from the audio, such that a mouth shape and a voice of the obtained animated character image are more closely integrated and are more consistent without incongruence, and such that the animated character in the broadcast video is more vivid and lively.

Alternatively, a speech-to-animation (STA) model may also be adopted to directly implement the broadcast video of the animated character image corresponding to the emotion of the character. The speech-to-animation model may be obtained by unified training of different types of models (e.g., a virtual image model and a speech synthesis model), can solve a mouth shape of a pronunciation corresponding to the speech in real time by combining artificial intelligence with computer graphics, and can finely drive the facial expression of the animated character image, to implement synchronous presentation of an audio and a video of animation.

Data involved in the training of the speech-to-animation model mainly includes image data, voice data, and text data. There is a certain intersection between the three kinds of data, that is, an audio in video data for training an image, audio data for training speech recognition, and audio data for training speech synthesis are consistent. Text data corresponding to the audio data for training speech recognition is consistent with text data corresponding to the audio for training the image. These consistencies are intended to improve the accuracy in the process of training the speech-to-animation model, and in addition, manually annotated data: such as an expression and an emotional characteristic of the image, is also required.

The speech-to-animation model includes: the virtual image model and the speech synthesis model. Modeling for a virtual image not only includes basic static models for, e.g., basic faces, facial contour, five sense organs, and trunk of the image, but also includes dynamic models for, e.g., mouth shapes, expressions, and actions of the image. In addition to a most basic timbre model, the speech synthesis model further incorporates the emotional characteristic of the character.

The method for human-computer interaction according to embodiments of the present disclosure first receives information of at least one modality of a user; then recognizes intention information of the user and an emotional characteristic of the user corresponding to the intention information based on the information of the at least one modality; then determines reply information to the user based on the intention information; then selects an emotional characteristic of a character to be fed back to the user based on the emotional characteristic of the user; and finally generates a broadcast video of an animated character image corresponding to the emotional characteristic of the character based on the emotional characteristic of the character and the reply information, thereby analyzing the information of the at least one modality of the user to determine the emotional characteristic of the character for the animated character image, providing effective emotional feedback for users with different emotions, and ensuring emotional communication during human-computer interaction.

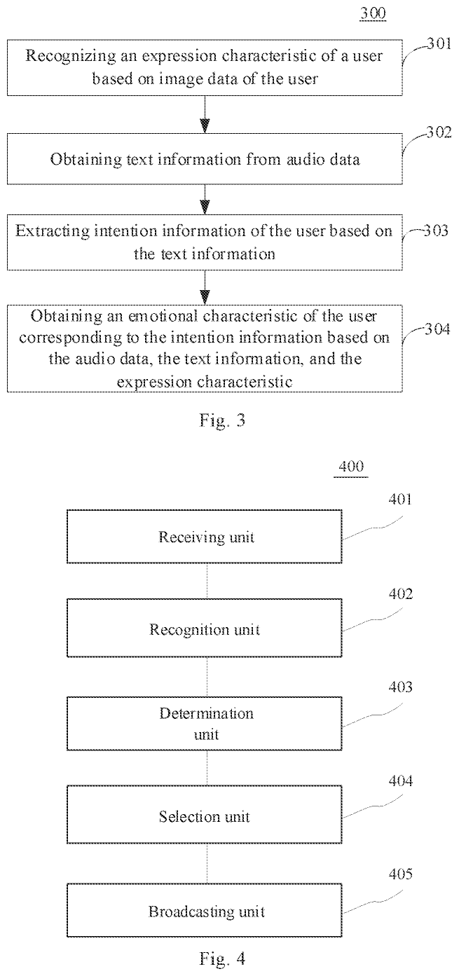

In another embodiment of the present disclosure, the information of the at least one modality includes image data and audio data of the user. As shown in FIG. 3, a process 300 of a method for recognizing intention information of a user and an emotional characteristic of the user in an embodiment of the present disclosure is shown. The method includes the following steps.

Step 301: recognizing an expression characteristic of the user based on image data of the user.

In the present embodiment, the recognizing the expression characteristic refers to positioning and extracting an organ characteristic, a texture region, and a predefined feature point of a human face. The recognizing the expression characteristic is also a key step in recognizing a facial expression, is also the key to face recognition, determines the final face recognition result, and directly affects the recognition rate.

In the present alternative implementation, the facial expression also belongs to a body language, an emotion of the user can be reflected through the facial expression, and each emotional characteristic of the user has a corresponding expression thereof.

The image data of the user includes face image data, which is analyzed to determine the expression characteristic of the user.

Alternatively, the image data of the user may further include body image data of the user, which is analyzed to further more clearly define the expression characteristic of the user.

Step 302: obtaining text information from audio data.

In the present embodiment, the text information may be obtained through a mature audio recognition model, for example, using an ASR (automatic speech recognition) model, which can convert a voice into a text. The audio data may be inputted into the ASR model to obtain the text outputted from the ASR model, thus achieving the purpose of recognizing the text information.

Step 303: extracting intention information of the user based on the text information.

In the present alternative implementation, the text information is information of the text converted from the audio data of the user. The intention information is obtained through a mature intention recognition model. For example, the text information is processed using a Natural Language Understanding (NLU) model by, e.g., sentence detection, word segmentation, part-of-speech tagging, syntactic analysis, text classification/clustering, or information extraction, to determine the intention information of the user.

Step 304: obtaining the emotional characteristic of the user corresponding to the intention information based on the audio data, the text information, and the expression characteristic.

In the present alternative implementation, when the emotional characteristic of the user is ascertained, the emotional characteristic of the user may be ascertained cooperatively from the audio data (tone) of the user and the expression characteristic of the user in combination with text information recognized by an audio model. This is more accurate than ascertaining the emotional characteristic of the user only according to the expression of the user or only according to voice information of the user, thereby facilitating selecting more suitable reply information and emotional characteristic of the character for application to the animated character image, and communicating with the user through the animated character image.

When the information of the modality of the user includes the image data and the audio data, the method for recognizing the intention information of the user and the emotional characteristic of the user provided in the present embodiment recognizes the expression characteristic of the user based on the image data; obtains the text information based on the audio data; extracts the intention information based on the text information; and further obtains the emotional characteristic of the user based on the audio data, the text information, and the expression characteristic. Therefore, the emotion of the user is comprehensively determined based on the emotions included in the facial expression (expression characteristic), the voice (audio data), and the speech (text information) of the user, thereby improving the reliability in analyzing the emotional characteristic of the user.

Further referring to FIG. 4, as an implementation of the method shown in the above figures, an embodiment of the present disclosure provides an apparatus for human-computer interaction. The embodiment of the apparatus corresponds to the embodiment of the method shown in FIG. 2, and the apparatus may be specifically applied to various electronic devices.

As shown in FIG. 4, the embodiment of the present disclosure provides an apparatus 400 for human-computer interaction. The apparatus 400 includes: a receiving unit 401, a recognition unit 402, a determination unit 403, a selection unit 404, and a broadcasting unit 405. The receiving unit 401 may be configured to receive information of at least one modality of a user. The recognition unit 402 may be configured to recognize intention information of the user and an emotional characteristic of the user corresponding to the intention information based on the information of the at least one modality. The determination unit 403 may be configured to determine reply information to the user based on the intention information. The selection unit 404 may be configured to select an emotional characteristic of a character to be fed back to the user based on the emotional characteristic of the user; and the broadcasting unit 405 may be configured to generate a broadcast video of an animated character image corresponding to the emotional characteristic of the character based on the emotional characteristic of the character and the reply information.

The specific processing of step 201, step 202, step 203, step 204, and step 205 in the corresponding embodiment of FIG. 2 and the technical effects thereof may be referred to for specific processing of the receiving unit 401, the recognition unit 402, the determination unit 403, the selection unit 404, and the broadcasting unit 405 of the apparatus 400 for human-computer interaction in the present embodiment and the technical effects thereof, respectively.

In some embodiments, the information of the at least one modality includes image data and audio data of the user. The recognition unit 402 includes: a recognition subunit (not shown in the figure), a text obtaining subunit (not shown in the figure), an extraction subunit (not shown in the figure), and a characteristic obtaining subunit (not shown in the figure). The recognition subunit may be configured to recognize an expression characteristic of the user based on the image data of the user. The text obtaining subunit may be configured to obtain text information from the audio data. The extraction subunit may be configured to extract the intention information of the user based on the text information. The characteristic obtaining subunit may be configured to obtain the emotional characteristic of the user corresponding to the intention information based on the audio data and the expression characteristic.

In some embodiments, the emotional characteristic of the user in the recognition unit is further obtained from the text information.

In some embodiments, the characteristic obtaining subunit includes: a speech obtaining module (not shown in the figure), an expression obtaining module (not shown in the figure), and a summation module (not shown in the figure). The speech obtaining module may be configured to input the audio data into a trained speech emotion recognition model to obtain a speech emotion characteristic outputted from the speech emotion recognition model. The expression obtaining module may be configured to input the expression characteristic into a trained expression emotion recognition model to obtain an expression emotion characteristic outputted from the expression emotion recognition model. The summation module may be configured to perform weighted summation on the speech emotion characteristic and the expression emotion characteristic to obtain the emotional characteristic of the user corresponding to the intention information.

In some embodiments, the information of the at least one modality includes the image data and the audio data of the user, and the recognition unit 402 includes: a recognition module (not shown in the figure), an extraction module (not shown in the figure), and a characteristic obtaining module (not shown in the figure). The recognition module may be configured to recognize the expression characteristic of the user based on the image data of the user. The extraction module may be configured to extract the intention information of the user based on text data. The characteristic obtaining module may be configured to obtain the emotional characteristic of the user corresponding to the intention information based on the text data and the expression characteristic.

In some embodiments, the broadcasting unit 405 includes: a generation subunit (not shown in the figure) and a video obtaining subunit (not shown in the figure). The generation subunit may be configured as the broadcasting unit. The video obtaining subunit may be configured to obtain the broadcast video of the animated character image corresponding to the emotional characteristic of the character based on the reply audio, the emotional characteristic of the character, and a pre-established animated character image model.

In some embodiments, the video obtaining subunit includes: a mouth shape driving module (not shown in the figure), an expression driving module (not shown in the figure), a model driving module (not shown in the figure), a picture obtaining module (not shown in the figure), and a video obtaining module (not shown in the figure). The video obtaining subunit includes: a mouth shape driving module configured to input the reply audio and the emotional characteristic of the character into a trained mouth shape driving model to obtain mouth shape data outputted from the mouth shape driving model; an expression driving module configured to input the reply audio and the emotional characteristic of the character into a trained expression driving model to obtain expression data outputted from the expression driving model; a model driving module configured to drive the animated character image model based on the mouth shape data and the expression data to obtain a three-dimensional model action sequence; a picture obtaining module configured to render the three-dimensional model action sequence to obtain a video frame picture sequence; and a video obtaining module configured to synthesize the video frame picture sequence to obtain the broadcast video of the animated character image corresponding to the emotional characteristic of the character. The mouth shape driving model and the expression driving model are trained based on a pre-annotated audio of the same person and audio emotion information obtained from the audio.

The apparatus for human-computer interaction according to embodiments of the present disclosure first receives, by the receiving unit 401, information of at least one modality of a user; then recognizes, by the recognition unit 402, intention information of the user and an emotional characteristic of the user corresponding to the intention information based on the information of the at least one modality; then determines, by the determination unit 403, reply information to the user based on the intention information; then selects, by the selection unit 404, an emotional characteristic of a character to be fed back to the user based on the emotional characteristic of the user; and finally generates, by the broadcasting unit 405, a broadcast video of an animated character image corresponding to the emotional characteristic of the character based on the emotional characteristic of the character and the reply information, thereby analyzing the information of the at least one modality of the user to determine the emotional characteristic of the character for the animated character image, providing effective emotional feedback for users with different emotions, and ensuring emotional communication during human-computer interaction.

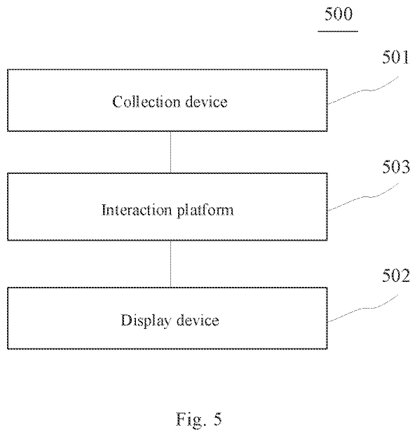

Further referring to FIG. 5, as an implementation of the method shown in the above figures, an embodiment of the present disclosure provides a system for human-computer interaction. The embodiment of the system corresponds to the embodiment of the method shown in FIG. 2.

As shown in FIG. 5, an embodiment of the present disclosure provides a system 500 for human-computer interaction. The system 500 includes: a collection device 501, a display device 502, and an interaction platform 503 connected to the collection device 501 and the display device 502 respectively. The collection device 501 is configured to collect information of at least one modality of a user. The interaction platform 503 is configured to receive the information of the at least one modality of the user; recognize intention information of the user and an emotional characteristic of the user corresponding to the intention information based on the information of the at least one modality; determine reply information to the user based on the intention information; select an emotional characteristic of a character to be fed back to the user based on the emotional characteristic of the user; and generate a broadcast video of an animated character image corresponding to the emotional characteristic of the character based on the emotional characteristic of the character and the reply information. The display device 502 is configured to receive and play the broadcast video.

In the present embodiment, the collection device is a device for collecting the information of the at least one modality of the user, and types of the collection device are different based on information of different modalities. For example, the information of the at least one modality includes image data and audio data of the user, and accordingly, the collection device may include a camera and a speaker. Further, if the information of the at least one modality includes text data of the user, the collection device may further include an input apparatus, such as a keyboard or a mouse.

In the present embodiment, the collection device 501, the display device 502, and the interaction platform 503 may be arranged separately, or may be integrated to form an integrated machine (e.g., the automatic teller machine or the terminal device in FIG. 1).

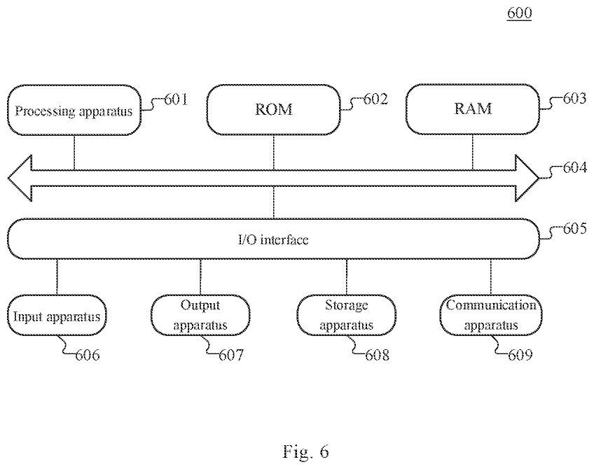

Referring to FIG. 6, FIG. 6 is a schematic structural diagram of an electronic device 600 adapted to implement embodiments of the present disclosure.

As shown in FIG. 6, the electronic device 600 may include a processing apparatus (e.g., a central processing unit and a graphics processing unit) 601, which may execute various appropriate actions and processes in accordance with a program stored in a read-only memory (ROM) 602 or a program loaded into a random access memory (RAM) 603 from a storage apparatus 608. The RAM 603 further stores various programs and data required by operations of the electronic device 600. The processing apparatus 601, the ROM 602 and the RAM 603 are connected to each other through a bus 604. An input/output (I/O) interface 605 is also connected to the bus 604.

Generally, the following components are connected to the I/O interface 605: an input apparatus 606 including a touch screen, a touch tablet, a keyboard, a mouse, etc.; an output apparatus 607 including such as a liquid crystal display device (LCD), a speaker, a vibrator, etc.; a storage apparatus 608 including a tape, a hard disk and the like; and a communication apparatus 609. The communication apparatus 609 may allow the electronic device 600 to communicate wirelessly or wired with other devices to exchange data. Although FIG. 6 shows electronic device 600 with various apparatus, it should be understood that it is not required to implement or have all of the apparatus shown. It may be implemented or have more or fewer apparatus instead. Each box shown in FIG. 6 may represent a single apparatus or multiple apparatus as needed.

In particular, according to the embodiments of the present disclosure, the process described above with reference to the flow chart may be implemented in a computer software program. For example, an embodiment of the present disclosure includes a computer program product, which includes a computer program that is tangibly embedded in a computer-readable medium. The computer program includes program codes for performing the method as illustrated in the flow chart. In such an embodiment, the computer program may be downloaded and installed from a network via the communication apparatus 609, or may be installed from the storage apparatus 608, or may be installed from the ROM 602. The computer program, when executed by the processing apparatus 601, implements the above-mentioned functionalities as defined by the method of the present disclosure.

It should be noted that the computer readable medium in the present disclosure may be computer readable signal medium or computer readable storage medium or any combination of the above two. An example of the computer readable storage medium may include, but not limited to: electric, magnetic, optical, electromagnetic, infrared, or semiconductor systems, apparatus, elements, or a combination of any of the above. A more specific example of the computer readable storage medium may include but is not limited to: electrical connection with one or more wire, a portable computer disk, a hard disk, a random access memory (RAM), a read only memory (ROM), an erasable programmable read only memory (EPROM or flash memory), a fiber, a portable compact disk read only memory (CD-ROM), an optical memory, a magnet memory or any suitable combination of the above. In the present disclosure, the computer readable storage medium may be any physical medium containing or storing programs which may be used by a command execution system, apparatus or element or incorporated thereto. In the present disclosure, the computer readable signal medium may include data signal in the base band or propagating as parts of a carrier, in which computer readable program codes are carried. The propagating data signal may take various forms, including but not limited to: an electromagnetic signal, an optical signal or any suitable combination of the above. The signal medium that can be read by computer may be any computer readable medium except for the computer readable storage medium. The computer readable medium is capable of transmitting, propagating or transferring programs for use by, or used in combination with, a command execution system, apparatus or element. The program codes contained on the computer readable medium may be transmitted with any suitable medium including but not limited to: wireless, wired, optical cable, RF medium etc., or any suitable combination of the above.

The above computer-readable medium may be included in the above server; or may be a stand-alone computer-readable medium without being assembled into the server. The computer-readable medium stores one or more programs, where the one or more programs, when executed by the server, cause the server to: receive information of at least one modality of a user; recognize intention information of the user and an emotional characteristic of the user corresponding to the intention information based on the information of the at least one modality; determine reply information to the user based on the intention information; select an emotional characteristic of a character to be fed back to the user based on the emotional characteristic of the user; and generate a broadcast video of an animated character image corresponding to the emotional characteristic of the character based on the emotional characteristic of the character and the reply information.

A computer program code for performing operations in the present disclosure may be compiled using one or more programming languages or combinations thereof. The programming languages include object-oriented programming languages, such as Java, Smalltalk or C++, and also include conventional procedural programming languages, such as “C” language or similar programming languages. The program code may be completely executed on a user's computer, partially executed on a user's computer, executed as a separate software package, partially executed on a user's computer and partially executed on a remote computer, or completely executed on a remote computer or server. In the circumstance involving a remote computer, the remote computer may be connected to a user's computer through any network, including local area network (LAN) or wide area network (WAN), or may be connected to an external computer (for example, connected through Internet using an Internet service provider).

The flow charts and block diagrams in the accompanying drawings illustrate architectures, functions and operations that may be implemented according to the systems, methods and computer program products of the various embodiments of the present disclosure. In this regard, each of the blocks in the flow charts or block diagrams may represent a module, a program segment, or a code portion, said module, program segment, or code portion including one or more executable instructions for implementing specified logic functions. It should also be noted that, in some alternative implementations, the functions denoted by the blocks may occur in a sequence different from the sequences shown in the accompanying drawings. For example, any two blocks presented in succession may be executed, substantially in parallel, or they may sometimes be in a reverse sequence, depending on the function involved. It should also be noted that each block in the block diagrams and/or flow charts as well as a combination of blocks may be implemented using a dedicated hardware-based system performing specified functions or operations, or by a combination of a dedicated hardware and computer instructions.

The units involved in the embodiments of the present disclosure may be implemented by software, or may be implemented by hardware. The described units may also be provided in a processor, for example, may be described as: a processor including a receiving unit, a recognition unit, a determination unit, a selection unit, and a broadcasting unit. The names of these units do not constitute a limitation to such units themselves in some cases. For example, the receiving unit may also be described as a unit “configured to receive information of at least one modality of a user.”

The above description only provides an explanation of the preferred embodiments of the present disclosure and the technical principles used. It should be appreciated by those skilled in the art that the inventive scope of the present disclosure is not limited to the technical solutions formed by the particular combinations of the above-described technical features. The inventive scope should also cover other technical solutions formed by any combinations of the above-described technical features or equivalent features thereof without departing from the concept of the present disclosure. Technical schemes formed by the above-described features being interchanged with, but not limited to, technical features with similar functions disclosed in the present disclosure are examples.

1. A method for human-computer interaction, comprising:
receiving information of at least one modality of a user;
recognizing intention information of the user and an emotional characteristic of the user corresponding to the intention information based on the information of the at least one modality;
determining reply information to the user based on the intention information;
selecting an emotional characteristic of a character to be fed back to the user based on the emotional characteristic of the user; and
generating a broadcast video of an animated character image corresponding to the emotional characteristic of the character based on the emotional characteristic of the character and the reply information.

2. The method according to claim 1, wherein
the information of the at least one modality comprises image data and audio data of the user, and
the recognizing the intention information of the user and the emotional characteristic of the user corresponding to the intention information based on the information of the at least one modality comprises:
recognizing an expression characteristic of the user based on the image data of the user;
obtaining text information from the audio data;
extracting the intention information of the user based on the text information; and
obtaining the emotional characteristic of the user corresponding to the intention information based on the audio data and the expression characteristic.

3. The method according to claim 2, wherein the recognizing the intention information of the user and the emotional characteristic of the user corresponding to the intention information based on the information of the at least one modality further comprises:
obtaining the emotional characteristic of the user further from the text information.

4. The method according to claim 2, wherein the obtaining the emotional characteristic of the user corresponding to the intention information based on the audio data and the expression characteristic comprises:
inputting the audio data into a trained speech emotion recognition model to obtain a speech emotion characteristic outputted from the speech emotion recognition model;
inputting the expression characteristic into a trained expression emotion recognition model to obtain an expression emotion characteristic outputted from the expression emotion recognition model; and
performing weighted summation on the speech emotion characteristic and the expression emotion characteristic to obtain the emotional characteristic of the user corresponding to the intention information.

5. The method according to claim 1, wherein the information of the at least one modality comprises image data and text data of the user; and
the recognizing the intention information of the user and the emotional characteristic of the user corresponding to the intention information based on the information of the at least one modality comprises:
recognizing an expression characteristic of the user based on the image data of the user;
extracting the intention information of the user based on the text data; and
obtaining the emotional characteristic of the user corresponding to the intention information based on the text data and the expression characteristic.

6. The method according to claim 1, wherein the generating the broadcast video of the animated character image corresponding to the emotional characteristic of the character based on the emotional characteristic of the character and the reply information comprises:
generating a reply audio based on the reply information and the emotional characteristic of the character; and
obtaining the broadcast video of the animated character image corresponding to the emotional characteristic of the character based on the reply audio, the emotional characteristic of the character, and a pre-established animated character image model.

7. The method according to claim 6, wherein the obtaining the broadcast video of the animated character image corresponding to the emotional characteristic of the character based on the reply audio, the emotional characteristic of the character, and the pre-established animated character image model comprises:
inputting the reply audio and the emotional characteristic of the character into a trained mouth shape driving model to obtain mouth shape data outputted from the mouth shape driving model;
inputting the reply audio and the emotional characteristic of the character into a trained expression driving model to obtain expression data outputted from the expression driving model;
driving the animated character image model based on the mouth shape data and the expression data to obtain a three-dimensional model action sequence;
rendering the three-dimensional model action sequence to obtain a video frame picture sequence; and
synthesizing the video frame picture sequence to obtain the broadcast video of the animated character image corresponding to the emotional characteristic of the character,
wherein the mouth shape driving model and the expression driving model are trained based on a pre-annotated audio of a same person and audio emotion information obtained from the audio.

8. An apparatus for human-computer interaction, comprising:
one or more processors; and
a storage apparatus storing one or more programs thereon,
wherein the one or more programs, when executed by the one or more processors, cause the one or more processors to perform operations, the operations comprising:
receiving information of at least one modality of a user;
recognizing intention information of the user and an emotional characteristic of the user corresponding to the intention information based on the information of the at least one modality;
determining reply information to the user based on the intention information;
selecting an emotional characteristic of a character to be fed back to the user based on the emotional characteristic of the user; and
generating a broadcast video of an animated character image corresponding to the emotional characteristic of the character based on the emotional characteristic of the character and the reply information.

9. A system for human-computer interaction, comprising: a collection device, a display device, and an interaction platform connected to the collection device and the display device respectively; wherein
the collection device is configured to collect information of at least one modality of a user;
the interaction platform is configured to receive the information of the at least one modality of the user; recognize intention information of the user and an emotional characteristic of the user corresponding to the intention information based on the information of the at least one modality; determine reply information to the user based on the intention information; select an emotional characteristic of a character to be fed back to the user based on the emotional characteristic of the user; and generate a broadcast video of an animated character image corresponding to the emotional characteristic of the character based on the emotional characteristic of the character and the reply information; and
the display device is configured to receive and play the broadcast video.

10. (canceled)

11. A non-transitory computer-readable medium, storing a computer program thereon, wherein the program, when executed by a processor, implements the method according to claim 1.

12. (canceled)

13. The apparatus according to claim 8, wherein the information of the at least one modality comprises image data and audio data of the user, and
the recognizing the intention information of the user and the emotional characteristic of the user corresponding to the intention information based on the information of the at least one modality comprises:
recognizing an expression characteristic of the user based on the image data of the user;
obtaining text information from the audio data;
extracting the intention information of the user based on the text information; and
obtaining the emotional characteristic of the user corresponding to the intention information based on the audio data and the expression characteristic.

14. The apparatus according to claim 13, wherein the recognizing the intention information of the user and the emotional characteristic of the user corresponding to the intention information based on the information of the at least one modality further comprises:
obtaining the emotional characteristic of the user further from the text information.

15. The apparatus according to claim 13, wherein the obtaining the emotional characteristic of the user corresponding to the intention information based on the audio data and the expression characteristic comprises:
inputting the audio data into a trained speech emotion recognition model to obtain a speech emotion characteristic outputted from the speech emotion recognition model;
inputting the expression characteristic into a trained expression emotion recognition model to obtain an expression emotion characteristic outputted from the expression emotion recognition model; and
performing weighted summation on the speech emotion characteristic and the expression emotion characteristic to obtain the emotional characteristic of the user corresponding to the intention information.

16. The apparatus according to claim 8, wherein the information of the at least one modality comprises image data and text data of the user; and
the recognizing the intention information of the user and the emotional characteristic of the user corresponding to the intention information based on the information of the at least one modality comprises:
recognizing an expression characteristic of the user based on the image data of the user;
extracting the intention information of the user based on the text data; and
obtaining the emotional characteristic of the user corresponding to the intention information based on the text data and the expression characteristic.

17. The apparatus according to claim 8, wherein the generating the broadcast video of the animated character image corresponding to the emotional characteristic of the character based on the emotional characteristic of the character and the reply information comprises:
generating a reply audio based on the reply information and the emotional characteristic of the character; and
obtaining the broadcast video of the animated character image corresponding to the emotional characteristic of the character based on the reply audio, the emotional characteristic of the character, and a pre-established animated character image model.

18. The apparatus according to claim 17, wherein the obtaining the broadcast video of the animated character image corresponding to the emotional characteristic of the character based on the reply audio, the emotional characteristic of the character, and the pre-established animated character image model comprises:
inputting the reply audio and the emotional characteristic of the character into a trained mouth shape driving model to obtain mouth shape data outputted from the mouth shape driving model;
inputting the reply audio and the emotional characteristic of the character into a trained expression driving model to obtain expression data outputted from the expression driving model;
driving the animated character image model based on the mouth shape data and the expression data to obtain a three-dimensional model action sequence;
rendering the three-dimensional model action sequence to obtain a video frame picture sequence; and
synthesizing the video frame picture sequence to obtain the broadcast video of the animated character image corresponding to the emotional characteristic of the character,
wherein the mouth shape driving model and the expression driving model are trained based on a pre-annotated audio of a same person and audio emotion information obtained from the audio.
